(19) United States
(12) Patent Application Publication
(10) Pub. No.: US 2025/0164976 A1
(43) Pub. Date: May 22, 2025

(54) MATERIAL SCHEDULING METHOD AND MACHINE

(71) Applicants: Fu Tai Hua Industry ( Shenzhen) Co., Ltd., Shenzhen (CN); HON HAI PRECISION INDUSTRY CO., LTD., New Taipei (TW)

(72) Inventor: ER-KAI TSAO, New Taipei (TW)

(21) Appl. No.: 18/674,716

(22) Filed: May 24, 2024

(30) Foreign Application Priority Data
Nov. 21, 2023 (CN) 202311573152.6

(51) Int. Cl. G05B 19/418

(52) U.S. Cl. CPC G05B 19/41865; G05B 19/4185; G05B 2219/32268

(57) ABSTRACT

A material scheduling method applied in a first machine is illustrated. In response to a processing instruction, the first machine controls a first downstream relay of at least one material transmission channel to send a high-level signal to make the second machine close a first upstream relay according to the high-level signal. The first machine obtains material information according to a classification signal, and receives the materials transmitted by the second machine, and controls a mechanical arm to separate the materials from a jig that places the materials. The first machine transmits the jig to the second machine through a jig return channel in response to a return signal sent by the second machine, and processes the materials transmitted by any material transmission channel in response that the material information indicates that the materials are unprocessed.

This application claims priority to Chinese Patent Application No. 202311573152.6 filed on Nov. 21, 2023, in China National Intellectual Property Administration, the contents of which are incorporated by reference herein.

### FIELD

The subject matter herein generally relates to a field of production management, in particular, relates to a material scheduling method and a machine.

### BACKGROUND

In a field of production and manufacturing, an upstream machine (for example, an equipment for producing material) communicates with a downstream machine (for example, an equipment that processes materials into final products) by using a Surface Mount Equipment Manufactures Association (SMEMA) standard protocol. The SMEMA standard protocol is a communication protocol and standardized interface for implementing automated surface mount lines. The SMEMA standard protocol defines a standard for transmitting a reference position of a PCB, and communication specifications between devices, so that equipment from different manufacturers can be interconnected, and collaborative work and information exchange on the production line can be realized. In related technologies, materials refer to clinker (materials that have been processed) processed from raw materials (materials that have not been processed). A signal channel between the upstream machine and the downstream machine can only transmit signals of the clinker. When the downstream machine needs to more materials, it needs to wait for the upstream machine to process the raw materials before receiving the clinker. Furthermore, there is only a single transmission channel of the material between the downstream machine and the upstream machine, which affects production efficiency of the downstream machine.

### BRIEF DESCRIPTION OF THE DRAWINGS

Implementations of the present disclosure will now be described, by way of embodiment, with reference to the attached figures.

FIG. 1 is an application scenario diagram of an embodiment of a material scheduling method provided by one embodiment of the present application.

FIG. 2 is a flowchart of an embodiment of the material scheduling method provided by one embodiment of the present application.

FIG. 3 is a schematic diagram of multiple upstream relays and multiple downstream relays provided by one embodiment of the present application.

FIG. 4 is a schematic diagram of a jig return channel and corresponding relays provided by one embodiment of the present application.

FIG. 5 is a flowchart of an embodiment of the material scheduling method provided by another embodiment of the present application.

### DETAILED DESCRIPTION

In order to facilitate understanding, some descriptions of concepts related to the embodiments of the present disclosure are given for reference.

It should be noted that in the present disclosure, “at least one” means one or more, and “multiple” means two or more than two. “And/or” describes an association relationship of associated objects, indicating that there can be three types of relationships, for example, A and/or B can mean A existing alone, A and B existing simultaneously, and B existing alone, and A, B can be singular or plural. The terms “first”, “second”, “third”, “fourth”, etc. (if any) in the description and claims of the present application and the drawings are used to distinguish similar objects, not to describe a particular order or sequence.

In a production and manufacturing field, an upstream machine (for example, an equipment for producing material) communicates with a downstream machine (for example, an equipment that processes materials into final products) by using a Surface Mount Equipment Manufactures Association (SMEMA) standard protocol. The SMEMA standard protocol is a communication protocol and standardized interface for implementing automated surface mount lines. The SMEMA standard protocol defines a standard for transmitting a reference position of a PCB, and communication specifications between devices, so that equipment from different manufacturers can be interconnected, and collaborative work and information exchange on the production line can be realized. In related technologies, materials refer to clinker (materials that have been processed) processed from raw materials (materials that have not been processed). A signal channel between the upstream machine and the downstream machine can only transmit signals of the clinker. When the downstream machine needs to use materials, it needs to wait for the upstream machine to process the raw materials before receiving the clinker. Furthermore, the transmission channel of the material is single between the downstream machine and the upstream machine, which affects production efficiency of the downstream machine.

In order to improve production efficiency, the embodiments of the present application provide a material scheduling method, a machine and a storage media. The application scenarios of the material scheduling method of the present application are illustrated as follow.

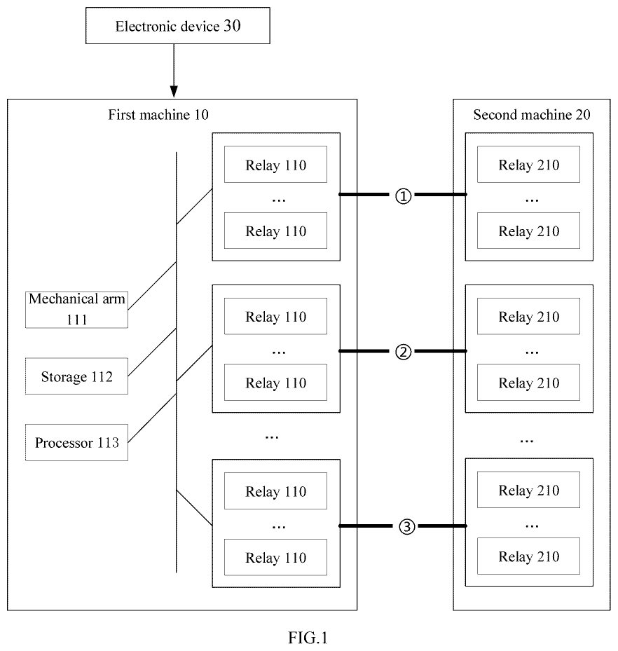

FIG. 1 illustrates an application scenario diagram of an embodiment of a material scheduling method provided by one embodiment of the present application. The material scheduling method provided by the embodiment of the present application is applied to a first machine 10. The first machine 10 is connected to a second machine 20 and an electronic device 30. The first machine 10 receives instructions, such as processing instructions, from the electronic device 30. When the first machine 10 receives the instructions from the electronic device 30, the first machine 10 is triggered to send signals to the second machine 20, so as to realize the material scheduling method.

The first machine 10 may be a device for processing materials, or a device for processing materials into products. In one embodiment, the first machine 10 includes, but is not limited to, a number of relays 110, a mechanical arm 111, a storage 112 and a processor 113.

The second machine platform 20 may be a device for providing materials for other processing equipment. In one embodiment, the second machine 20 includes a number of relays 210.

In some embodiments of the present application, a number of material transmission channels (for example, channel \textcircled{1} and channel \textcircled{2} in FIG. 1) and at least one jig return channel (channel \textcircled{3} as shown in FIG. 1), each channel corresponds to multiple relays of the first machine 10 and the second machine 20. There is a one-to-one correspondence between the multiple relays corresponding to the same channel. The corresponding relationship between each of the number of the relays 110 and each of the number of the relays 210 may be fixed, so that an independent communication link can be established between each of the number of the relays 110 and each of the number of the relays 210.

In one embodiment, in the same channel, the relay 110 includes a first downstream relay, and the relay 210 includes a first upstream relay. When the second machine 20 detects that the first downstream relay is closed, the second machine 20 controls the first upstream relay to close. The above names used to describe the upstream relay and the downstream relay are only to distinguish the relays in different machines, and do not limit an execution order of the relays. For example, in other embodiments, in order to distinguish the relay 110 and the relay 210, the first relay 110 of the machine 10 is called a downstream relay, and different downstream relays are distinguished by first, second, third, etc., for example, the first downstream relay. The relay 210 of the second machine 20 can be called an upstream relay. Different upstream relays are distinguished by first, second, third, etc., for example, the first upstream relay. The above description is only for distinguishing different relays, and the present application will not limit other description methods of the first upstream relay.

In some embodiments of the present application, the first machine 10 manages communication with the second machine 20 by controlling multiple relays 110. For example, when any relay 110 of any channel is in a closed state, then the communication between the first machine 10 and the second machine 20 is established. When all the relays 110 are in an off state, the communication between the first machine 10 and the second machine 20 is disconnected. The first machine 10 can control the mechanical arm 111 to perform operations by the processor 113, for example, the mechanical arm 111 can be controlled to transport materials, separate materials from a jig, etc. The storage 112 is used to store information of the first machine 10, for example, the first machine 10 receives the material information sent by the second machine 20.

In one embodiment, the relay 110 may be a solid-state relay, an electromagnetic relay or other types of relays, which is not limited in the present application.

In one embodiment, the mechanical arm 111 may be a component installed on the first machine 10 that can perform operations such as a grabbing operation or a placing operation.

In one embodiment, the storage 112 may include one or more random access memories (RAM) and one or more non-volatile memories (NVM). The RAM can be directly read and written by the processor 113 and can be used to store executable programs (such as machine instructions) of an operating system or other running programs. The RAM can also be used to store user and application data. The RAM can be a static random-access memory (SRAM), a dynamic random access memory (DRAM), a synchronous dynamic random access memory (SDRAM), a double data rate synchronous dynamic random access memory (DDR SDRAM), etc.

The non-volatile memory can also store executable programs, and user and application data, etc., and the non-volatile memory can be loaded into the RAM in advance for direct reading and writing by the processor 113. In one embodiment, the non-volatile memory can include disk storage devices and flash memory.

The storage 112 is used to store one or more computer programs. One or more computer programs are configured for execution by the processor 113. The one or more computer programs include a number of instructions. When the number of instructions are executed by the processor 113, the material scheduling method executed on the first machine 10 can be implemented.

In one embodiment, the electronic device 30 may be a mobile phone, a tablet computer, a notebook computer, a netbook, or other electronic device. The embodiment of the present application does not place any restrictions on the specific type of the electronic device 30.

It can be understood that a structure illustrated in the embodiment of the present application does not constitute a specific limitation on the first machine 10. In other embodiments of the present application, the first machine 10 may include more components or less components than shown in the figures, or some components may be combined, some components may be separated, or some components may be arranged differently. The components illustrated may be implemented in hardware, software, or a combination of software and hardware.

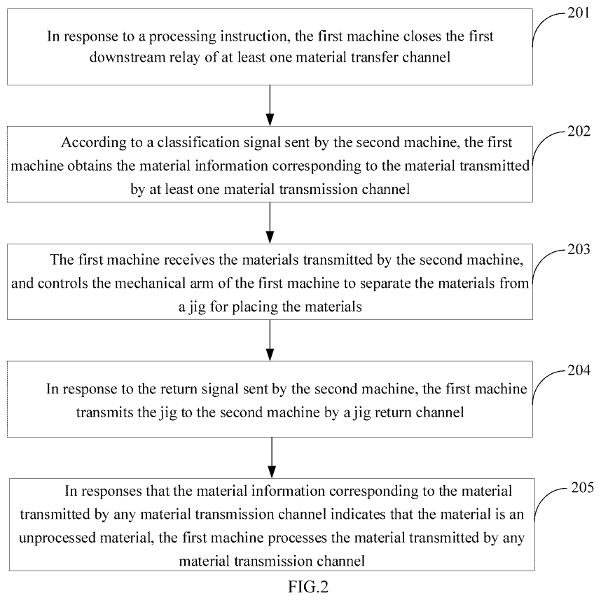

In order to solve a problem of low production efficiency, a material scheduling method is provided. Referring to FIG. 2, FIG. 2 illustrates a flowchart of an embodiment of the material scheduling method provided by one embodiment of the present application. The method is applied to the first machine (such as the first machine 10 in FIG. 1). Depending on different needs, the order of steps in the flowchart can be changed and some steps can be omitted.

At block 201, in response to a processing instruction, the first machine closes the first downstream relay of at least one material transfer channel.

In some embodiments of the present application, the electronic device is communicatively connected to the first machine for controlling the processing of the first machine. The electronic device can issue instructions to the first machine according to a preset logic program, for example, processing instructions. The electronic device triggers the first machine to start executing the processing program and production program by issuing the processing instructions to the first machine, realizing an automated production of the first machine. In one embodiment, the processing instructions can carry processing information, and the processing information can include the number of produced products, the number of materials required, etc.

In one example, taking the electronic device as a computer as an example, the first machine may be a machine tool for producing products to be produced. The machine tool is a mechanical equipment used to process materials such as metals and plastics. According to the processing instructions triggered when the user operates the logic program running on the computer, the first machine starts to execute the processing program and production program. For example, the first machine can perform cutting, drilling, milling, grinding and other operations on the components, and can produce products such as shaft components, and subsequent processing on the first machine can achieve automated production without relying on a computer control.

In some embodiments of the present application, there are multiple relays in the first machine, and closing different relays means different instructions. For example, closing the first downstream relay in the first machine means that the first machine needs materials. When the first downstream relay is turned off after closing, it means that the first machine stops receiving materials.

In some embodiments of the present application, multiple material transmission channels are defined between the first machine and the second machine. Closing relays corresponding to different material transmission channels has different instructions. For example, when the first machine closes the first downstream relay corresponding to the first material transmission channel, it means that the first machine opens the first material transmission channel to receive materials, and triggers the second machine to close the first upstream relay corresponding to the first material transmission channel. For another example, when the first machine closes the first downstream relay corresponding to the first material transmission channel and the first downstream relay corresponding to the second material transmission channel at the same time, it means that the first machine turns on the first material transmission channel and the second material transmission channel to receive materials, and triggers the second machine to close the first upstream relay corresponding to the first material transmission channel, and close the first upstream relay corresponding to the second material transmission channel.

In some embodiments of the present application, the first machine can select a material transmission channel for transporting materials according to the processing instructions, and trigger the corresponding material transmission channel to start working by changing the first downstream relay of the material transmission channel, that is, triggering the corresponding material transfer device (for example, conveyor belt) starts working. When the first machine closes the first downstream relay of at least one material transmission channel, the first downstream relay sends a high level signal to the second machine, causing the second machine to close the first upstream relay corresponding to the first downstream relay, and trigger the second machine to start a material transmission mode to transmit materials.

In one embodiment, when the first machine receives one processing instruction, the first machine obtains the processing information carried by the processing instruction. The processing information includes a material quantity. When the material quantity is less than a preset threshold, any material transmission channel can be used to transfer the material. When the quantity of materials is greater than the preset threshold, in order to speed up the transmission efficiency of the materials, multiple material transmission channels can be used to transmit the materials. In one embodiment, the preset threshold can be set according to the actual production situation and is not limited by the present application.

When the first machine determines to use the first material transmission channel and the second material transmission channel according to the material quantity, the first downstream relay corresponding to the first material transmission channel is closed, and the first downstream relay corresponding to the second material transmission channel is closed. In one embodiment, when closing the first downstream relay corresponding to the first material transmission channel, the first downstream relay corresponding to the first material transmission channel sends a high-level signal to the second machine, so that the second machine starts the material transmission mode of using the first material transmission channel for transmitting materials by closing the first upstream relay corresponding to the first material transmission channel.

Similarly, when closing the first downstream relay corresponding to the second material transmission channel and sending a high-level signal to the second machine, the second machine starts the material transmission mode of using the second material transmission channel for transmitting materials by closing the first upstream relay corresponding to the second material transmission channel. In one embodiment, When the first machine closes the first downstream relay corresponding to the first material transmission channel, the transmission device on the first material transmission channel is started to work. In one embodiment, the transmission device can be a conveyor belt. Similarly, when the first machine closes the first downstream relay corresponding to the second material transmission channel, the transmission device on the second material transmission channel is started to work.

In one embodiment of the present application, the second machine can determine the material transmission channel to be opened according to the material quantity or other processing information, which can improve the transmission efficiency of logistics and the processing efficiency and production efficiency of the second machine to a certain extent.

At block 202, according to a classification signal sent by the second machine, the first machine obtains the material information corresponding to the material transmitted by at least one material transmission channel.

In some embodiments of the present application, after triggering the second machine to start the material transmission mode, the material information carried by the classification signal can be obtained according to the received classification signal. The material information includes at least one of following types of information: indicating that the corresponding materials transmitted by at least one material transmission channel are unprocessed materials, indicating that the corresponding materials transmitted by at least one material transmission channel are processed and qualified materials, indicating that at least one material transmission channel transmits corresponding materials that have been processed and unqualified. In other embodiments, the material information may also indicates the materials that have not completed processing.

In some embodiments of the present application, both the first machine and the second machine include signal output terminals and signal input terminals, and the first machine and the second machine can poll each other, for example, the first machine can poll the signal output terminals of the second machine to obtain outputting signals output by the second machine, and the second machine can poll the signal output terminals of the first machine to obtain the outputting signals output by the first machine. In one embodiment, polling is a way of periodically issuing queries. The signal output terminals of the first machine and the second machine can also actively send signals to each other. For example, when the first machine and the second machine establish a connection, the signal output terminals of the first machine can actively send signals to the second machine to establish a communication link. The application does not limit obtaining each other's signals between the first machine and the second machine.

In one embodiment, the first machine can receive the classification signal sent by the second machine, and the first machine can also obtain the classification signal output by the second machine by active polling.

In some embodiments of the present application, the first machine can obtain material information corresponding to the material transmitted by the corresponding material transmission channel according to the classification signal. There are multiple material transmission channels between the first machine and the second machine. Each material transfer channel corresponds to multiple downstream relays of the first machine and multiple upstream relays of the second machine. For example, the first material transfer channel corresponds to a first downstream relay, a second downstream relay, a third downstream relay, a fourth downstream relay and a fifth downstream relay of the first machine, and the second machine corresponding to the first material transmission channel may include a first upstream relay, a second upstream relay, a third upstream relay, a fourth upstream relay, and a fifth upstream relay.

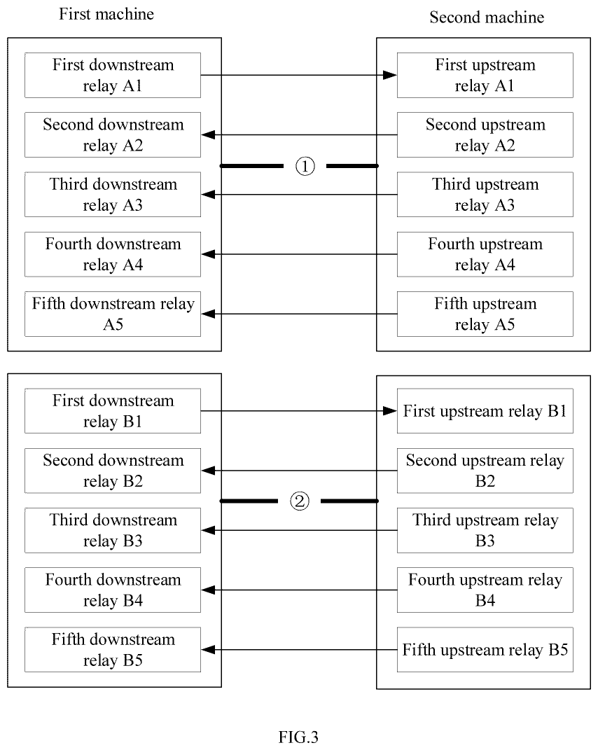

FIG. 3 illustrates a schematic diagram of multiple upstream relays and multiple downstream relays provided by one embodiment of the present application. As shown in FIG. 3, the first machine is provided with a first downstream relay A1, a second downstream relay A2, a third downstream relay A3, a fourth downstream relay A4, a fifth downstream relay A5, a first downstream relay B1, and a second downstream relay B2, a third downstream relay B3, a fourth downstream relay B4, and a fifth downstream relay B5. The second machine is provided with the first upstream relay A1, the second upstream relay A2, the third upstream relay A3, the fourth upstream relay A4, the fifth upstream relay A5, the first upstream relay B1, the second upstream relay B2, the third upstream relay B3, the fourth upstream relay B4, and the fifth upstream relay B5. There is a first material transmission channel (channel 1 of FIG. 3) and a second material transmission channel (channel 2 of FIG. 3) between the first machine and the second machine.

As shown in FIG. 3, the first material transmission channel corresponds to the first downstream relay A1, the second downstream relay A2, the third downstream relay A3, the fourth downstream relay A4, the fifth downstream relay A5 of the first machine, and the first upstream relay A1, the second upstream relay A2, the third upstream relay A3, the fourth upstream relay A4 and the fifth upstream relay A5 of the second machine. The second material transmission channel corresponds to the first downstream relay B1, the second downstream relay B2, the third downstream relay B3, the fourth downstream relay B4, the fifth downstream relay B5 of the first machine, and the first upstream relay B1, the second upstream relay B2, the third upstream relay B3, the fourth upstream relay B4, and the fifth upstream relay B5. In one embodiment, the relays in the first machine and the second machine have a one-to-one correspondence. For example, the first upstream relay A1 is connected to the first downstream relay A1, and the first downstream relay A1 can send a signal to the first upstream relay A1. Moreover, the number of corresponding relays on each material transmission channel may be the same or different, and the meanings represented by the corresponding relays on each material transmission channel may be the same or different, which is not limited by the present application.

For example, in one embodiment, closing the first downstream relay A1 indicates that the first machine needs materials, closing the first downstream relay B1 may also indicate that the first machine needs materials, and closing the first downstream relay may cause the first upstream relay to close, thus triggering the second machine to start the material transmission mode.

In some embodiments of the present application, after triggering the second machine to start the material transmission mode, the first machine can obtain the material information carried by the classification signal according to the received classification signal. Taking opening a material transmission channel as an example to illustrate, such as channel (1) shown in FIG. 3. When the classification signal is a high-level signal output by the second upstream relay A2 of the second machine corresponding to the first material transmission channel (channel (1) as shown in FIG. 3), the corresponding material information indicates that the material transmitted by the first material transfer channel is unprocessed is determine. Specifically, when the second machine closes the second upstream relay A2, the second downstream relay A2 can receive the high-level signal output by the second upstream relay A2, and the first machine closes the second downstream relay A2, which indicates that the material information obtained by the first machine indicates that the material is unprocessed.

When the classification signal is a high-level signal output by the third upstream relay A3 of the second machine corresponding to the first material transmission channel (channel (1) as shown in FIG. 3), the corresponding material information indicates that the material transmitted by the first material transfer channel is processed and qualified. Specifically, when the second machine closes the third upstream relay A3, the third downstream relay A3 can receive the high-level signal output by the third upstream relay A3, and the first machine closes the third downstream relay A3, which indicates that the material information obtained by the first machine indicates that the material has been processed and are qualified.

when the classification signal is a high-level signal output by the fourth upstream relay A4 of the second machine corresponding to the first material transmission channel (channel \textcircled{1} as shown in FIG. 3), the corresponding material information indicates that the material has been processed and are unqualified. Specifically, when the second machine closes the fourth upstream relay A4, the fourth downstream relay A4 can receive the high-level signal output by the fourth upstream relay A4, and the first machine closes the fourth downstream relay A4, which indicates that the material information obtained by the first machine indicates that the material has been processed and are unqualified.

In some embodiments of the present application, the classification signal corresponding to the same material transmission channel includes the high-level signal output by the second upstream relay, the high-level signal output by the third upstream relay, and the high-level signal output by the fourth upstream relay. In order to ensure that the material being transmitted is the material indicated by the same material information and avoid material information disorder, if at least two high-level signals of the high-level signal output by the second upstream relay, the output of the third upstream relay, and the high-level signal of the fourth upstream relay corresponding to the same material transmission channel, are received at the same time, the user is prompted to check whether the first machine is faulty and make timely adjustments.

In some embodiments of the present application, if a high-level signal from the fifth upstream relay A5 is received and the fifth downstream relay A5 is closed, it indicates that it has received a signal from the second machine to confirm that there is material. In one embodiment, the first machine can receive the classification signal and the high-level signal sent by the fifth upstream relay A5 at the same time. Alternatively, the first machine can first receive the high-level signal sent by the fifth upstream relay A5 and determine whether the second machine has materials can be provided, and then classification signals can be received to obtain material information, which are not limited in the present application.

In other embodiments of the present application, the opening of two material transmission channels is used as an example for explanation, such as channel \textcircled{1} and channel \textcircled{2} shown in FIG. 3. The types of materials transported by the two material transmission channels can be the same or different, for example, if the classification signals are the high-level signal output by the second upstream relay A2, and the high-level signal output by the second upstream relay B2, it is determined that the material information corresponding to the materials transmitted by the first material transmission channel and the second material transmission channel, indicates that the materials are unprocessed materials.

If the classification signals are the high-level signal output by the second upstream relay A2 and the high-level signal output by the third upstream relay B3, it is determined that the material information corresponding to the material transmitted by the first material transmission channel indicates that the material is unprocessed, and determined that the material information corresponding to the material transmitted by the second material transmission channel indicates that the material has been processed and are qualified.

The above embodiments are just examples. The material information corresponding to the material received by the first machine is determined according to the classification signals corresponding to different material transmission channels, and will not be described here.

At block 203, the first machine receives the materials transmitted by the second machine, and controls the mechanical arm of the first machine to separate the materials from a jig for placing the materials.

In some embodiments of the present application, before the first machine receives the materials transmitted by the second machine, if receiving the low-level signals output by the second upstream relay, the third upstream relay, the fourth upstream relay and the fifth upstream relay, level signal, the first machine adjusts the second downstream relay, the third downstream relay, the fourth downstream relay and the fifth downstream relay corresponding to the material transmission channel from the closed state to the open state, indicating that the second machine starts to transmit materials, and the first machine starts timing. Within a preset time, when the first machine does not receive any materials transmitted from the second machine, an early warning prompt is issued to prompt the user to check whether the first machine is faulty or whether the material is faulty during the transmission process. In one embodiment, the preset time can be customized and can be determined according to a length and a transmission speed of the transmission belt, which is not limited by the present application.

In some embodiments of the present application, after receiving the materials transmitted by the second machine, the first machine can adjusts the state of the first downstream relay in the first machine to the open state, so that a communication between the first machine and the second machine is disconnected, and the second machine stops transmitting materials to the first machine, and the first machine starts the processing mode and process the received materials.

In some embodiments of the present application, when the first machine receives the materials, the first machine also receives the jig for placing the materials. The jig can be recycled. Therefore, when the first machine receives the materials and the jig, the first machine can control the mechanical arm to separate the materials from the jig. The materials are used to produce products, and the jig is used to return to the second machine.

At block 204, in response to the return signal sent by the second machine, the first machine transmits the jig to the second machine by a jig return channel.

In some embodiments of the present application, the jig return channel is provided between the first machine and the second machine. The jig return channel corresponds to multiple downstream relays of the first machine and multiple upstream relays of the second machine.

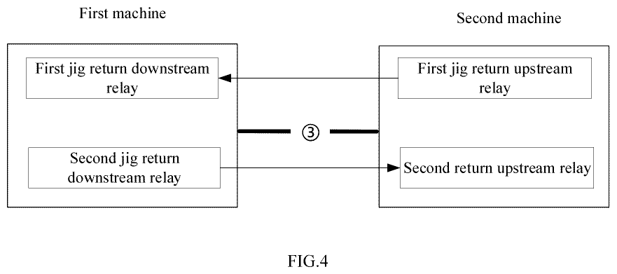

FIG. 4 illustrates a schematic diagram of a jig return channel and corresponding relays provided by one embodiment of the present application. As shown in FIG. 4, the jig return channel (channel \textcircled{3} shown in FIG. 4) is used to transmit the jig from the first machine to the second machine. The relays of the jig return channel corresponding to the first machine include a first jig return downstream relay and a second jig return downstream relay. The relays of the jig return channel corresponding to the second machine include a first jig return upstream relay and a second return upstream relay. In one embodiment, the first jig return downstream relay is correspondingly connected with the first jig return upstream relay, and the second jig return downstream relay is correspondingly connected with the second jig return upstream relay.

In some embodiments of the present application, when the first machine detects the high-level sent by the first jig return upstream relay of the first fixture, the first machine closes the first jig return downstream relay and detects whether there is a jig to be returned in the first machine. If the first machine has the jig to be returned, the first machine closes the second jig return downstream relay, triggers the second machine to close the second jig return downstream relay, and after the first machine placing separated jig in the jig return channel, the second jig return downstream relay is disconnected, causing the second machine to disconnect the second jig return upstream relay, indicating that the jig starts to transmit, and triggers the first machine and the second machine starts timing. If the second machine does not receive the jig within the preset time, a fault warning will be issued.

In some embodiments of the present application, when the second machine receives the jig, since transmitting jig is generated after the material is transmitted, when the material transmission on the material transmission channel does not stop, the first jig upstream relay of cannot be disconnected until the material transmission is completed.

At block 205, in responses that the material information corresponding to the material transmitted by any material transmission channel indicates that the material is an unprocessed material, the first machine processes the material transmitted by any material transmission channel.

In some embodiments of the present application, based on the material transmission channel opened by the first machine, the material information corresponding to the material transmitted on each opened material transmission channel may be the same or different. If there is any information corresponding to the material transmitted by any material transmission channel indicates that the material is an unprocessed material, and the material transmitted by any material transmission channel are processed.

For example, in one embodiment, the material information corresponding to the material transmitted by the first material transmission channel indicates that the material is the unprocessed material, and the material information corresponding to the material transmitted by the second material transmission channel indicates that the material has been processed and are qualified, when the first machine receives the material transmitted on the first material transmission channel, the first machine processes the material to produce the processed material, and then based on the processed material and the processed material transmitted on the second material transmission channel, the first machine produces products.

In another embodiment, based on the material information, it is determined that the materials transmitted by any material transmission channel are processed and unqualified, the processed and unqualified materials are removed from the first machine, and the first downstream relay corresponding to any material transmission channel is re-closed to receive new materials again.

In another embodiment, based on the material information, if it is determined that the material transmitted by the material transmission channel is processed and qualified, the first machine produces products based on the processed and qualified material. For example, in one example, initial parts are produced based on tempered materials, and then the initial parts are processed into shaft parts (products).

In one embodiment of the present application, based on the processing instructions, one or more material transmission channels are opened by closing the first downstream relay corresponding to the material transmission channel, which improves the efficiency of material transmission to a certain extent. When the first machine closes the first downstream relay of at least one material transmission channel, the second machine is triggered to close the first upstream relay of the corresponding material transmission channel, so that the second machine begins to feed back the classification signal to the first machine. The first machine obtains the material information corresponding to the material by obtaining the classification signal, so that the first machine can perform corresponding processing when receiving the material. When the first machine receives the material, the first machine controls the mechanical arm to separate the material from the jig for placing the material. When receiving the return signal from the second machine, the first machine transmits the jig to the second machine by the jig return channel, thus the jig can be sent back to the second machine without affecting the receipt of materials. On the one hand, it can avoid the accumulation of jigs on the first machine, and on the other hand, it can improve the utilization rate of the jigs. When the first machine receives unprocessed materials, it can process the unprocessed materials before producing. The first machine can produce products without receiving processed materials, thus improving the production efficiency of the first machine to a certain extent.

In addition, the embodiment of the present application can use multiple material transmission channels for parallel transmission. The materials transmitted by different material transmission channels can be the same or different, which allows the first machine to perform corresponding processing according to the different received materials, speeding up the process of material delivery. At the same time, the present application also includes the jig return channel, which can return the jig to the second machine without affecting the material transmission, so that the second machine can recycle the jig, achieving for the purpose of cost saving.

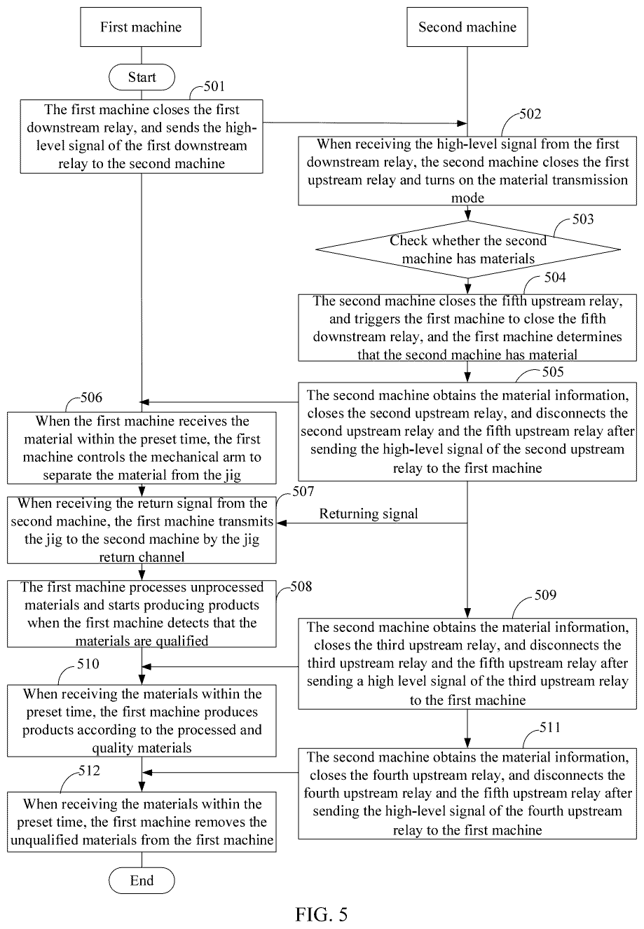

FIG. 5 illustrates a flowchart of an embodiment of the material scheduling method provided by another embodiment of the present application. As shown in FIG. 5, in order to better illustrate the transmission between the first machine and the second machine, a transmission method of a single material transmission channel is provided. It can be understood that when there are multiple material transmission channels to transmit the materials, the embodiment shown in FIG. 5 can be executed correspondingly on multiple material transmission channels. The relays mentioned in the embodiment shown in FIG. 5 all correspond to the same material transmission channel, including the following steps.

At block 501, in response to the processing instruction issued by the electronic device, the first machine closes the first downstream relay, and sends a high-level signal of the first downstream relay to the second machine.

At block 502, when receiving the high-level signal from the first downstream relay, the second machine closes the first upstream relay and turns on the material transmission mode.

At block 503, after the second machine turning on the material transmission mode, the second machine starts to check whether the second machine has materials. If the second machine has materials, block 504 is executed, if the second machine does not have materials, block 503 is continued.

At block 504, the second machine closes the fifth upstream relay, and triggers the first machine to close the fifth downstream relay, and the first machine determines that the second machine has material.

At block 505, the second machine obtains the material information, in response that the material information indicates that the material is the unprocessed material, the second machine closes the second upstream relay, and after sending the high-level signal of the second upstream relay to the first machine, the second machine disconnects the second upstream relay and the fifth upstream relay, indicating that the second machine starts to transmit materials.

In some embodiments of the present application, the second machine sends the high-level signal of the second upstream relay to the first machine, triggering the first machine to close the second downstream relay. When the second machine disconnects the second upstream relay and the fifth upstream relay and sends the low-level signals of the second upstream relay and the fifth upstream relay to the first machine, the first machine disconnects the second downstream relay and the fifth upstream relay.

At block 506, when the first machine receives the material within the preset time, the first machine controls the mechanical arm to separate the material from the jig.

At block 507, when receiving the return signal from the second machine, the first machine transmits the jig to the second machine by the jig return channel.

In some embodiments of the present application, when the first machine receives the material within the preset time, the first machine controls the mechanical arm to separate the jig and the material. When the first machine receives a return signal from the second machine, the first machine controls the mechanical arm to place the material on the jig to transfer the jig to the second machine within the preset time.

At block 508, the first machine processes unprocessed materials and starts producing products when the first machine detects that the materials are qualified.

At block 509, the second machine obtains the material information, if the material information indicates that the material is processed and qualified, the second machine closes the third upstream relay, and after sending a high level signal of the third upstream relay to the first machine, the second machine disconnects the third upstream relay and the fifth upstream relay, indicating that the second machine starts to transmit materials.

In some embodiments of the present application, the second machine sends the high level signal of the third upstream relay to the first machine, triggering the first machine to close the third downstream relay. When the second machine disconnects the third upstream relay and the fifth upstream relay and sends the low-level signals of the third upstream relay and the fifth upstream relay to the first machine, the first machine disconnects the third downstream relay and the fifth downstream relay.

At block 510, when receiving the materials within the preset time, the first machine produces products according to the processed and quality materials.

At block 511, the second machine obtains the material information, if the material information indicates that the material is processed and unqualified, the second machine closes the fourth upstream relay, and after sending the high-level signal of the fourth upstream relay to the first machine, the second machine disconnects the fourth upstream relay and the fifth upstream relay, indicating that the second machine starts to transmit materials.

In some embodiments of the present application, the second machine sends the high-level signal of the fourth upstream relay to the first machine, triggering the first machine to close the fourth downstream relay. When the second machine disconnects the fourth upstream relay and the fifth upstream relay and sends the low-level signals of the fourth upstream relay and the fifth upstream relay to the first machine, the first machine disconnects the fourth downstream relay and the fifth downstream relay.

At block 512, when receiving the materials within the preset time, the first machine removes the unqualified materials from the first machine, and returns to block S501.

Embodiments of the present application also provide a computer-readable storage medium. A computer program is stored on the computer-readable storage medium. The computer program includes program instructions. The method implemented when the program instructions are executed may refer to the methods in the above-mentioned embodiments of the present application.

The computer-readable storage medium may be the internal memory of the first machine described in the above embodiments, such as the hard disk or memory of the first machine. The computer-readable storage medium may also be an external storage device of the first machine, such as a plug-in hard disk, a smart memory card (SMC), or a Secure Digital (SD) card, Flash Card, etc.

In some embodiments, the computer-readable storage medium may include a storage program area and a storage data area, wherein the storage program area may store an operating system, at least one application program required for a function, etc., the storage data area may store data created based on use of the electronic device and the like.

In the above embodiments, each embodiment is described with its own emphasis. For parts that are not detailed or documented in a certain embodiment, please refer to the relevant descriptions of other embodiments.

It can be understood that the module division described above is a logical function division, and there may be other division methods in actual implementation. In addition, each functional module in each embodiment of the present disclosure may be integrated into a same processing unit, or each module may exist separately physically, or two or more modules may be integrated into a same unit. The above-mentioned integrated modules can be implemented in the form of hardware, or in the form of hardware plus software function modules.

The above description only represents some embodiments of the present disclosure and is not intended to limit the present disclosure, and various modifications and changes can be made to the present disclosure. Any modifications, equivalent substitutions, improvements, etc. made within the spirit and scope of the present disclosure are intended to be included within the scope of the present disclosure.

What is claimed is:

1. A material scheduling method, applied in a first machine, the method comprising:
in response to a processing instruction, controlling a first downstream relay of at least one material transmission channel to send a high-level signal to a second machine by closing the first downstream relay, making the second machine close a first upstream relay of the at least one material transmission channel according to the high-level signal, and triggering the second machine to activate a material transmission mode;
obtaining material information corresponding to materials transmitted by the at least one material transmission channel according to a classification signal fed back by the second machine;
receiving the materials transmitted by the second machine, and controlling a mechanical arm on the first machine to separate the materials from a jig that places the materials;
in response to a return signal sent by the second machine, transmitting the jig to the second machine through a jig return channel;
in response that the material information corresponding to the materials transmitted by any material transmission channel indicates that the materials are unprocessed, processing the materials transmitted by any material transmission channel.

2. The material scheduling method as recited in claim 1, wherein obtaining material information corresponding to materials transmitted by the at least one material transmission channel according to the classification signal fed back by the second machine, comprises:
in response that the classification signal is a high-level signal output by a second upstream relay of the at least one material transmission channel corresponding to the second machine, determining that the material information corresponding to the materials transmitted by the at least one material transmission channel indicates that the materials are unprocessed; or
in response that the classification signal is a high-level signal output by a third upstream relay of the at least one material transmission channel corresponding to the second machine, determining that the material information corresponding to the materials transmitted by the at least one material transmission channel indicates that the materials are processed and qualified; or
in response that the classification signal is a high-level signal output by a fourth upstream relay of the at least one material transmission channel corresponding to the second machine, determining that the material information corresponding to the materials transmitted by the at least one material transmission channel indicates that the materials are processed and unqualified.

3. The material scheduling method as recited in claim 1, wherein before in response to a return signal sent by the second machine, the method further comprises:
after receiving the materials transmitted by the second machine, disconnecting the first downstream relay corresponding to the at least one material transmission channel, and disconnecting a communication between the first machine and the second machine.

4. The material scheduling method as recited in claim 3, wherein after disconnecting the first downstream relay corresponding to the at least one material transmission channel and disconnecting a communication between the first machine and the second machine, the method further comprises:
in response that the materials transmitted by any material transmission channel are processed and unqualified according to the material information, removing the materials out of the first machine, and re-closing the first downstream relay corresponding to any one of the material transmission channels, and continuing to receive other materials.

5. The material scheduling method as recited in claim 2, further comprising:
when receiving at least two high-level signals of the high-level signal output by the second upstream relay, the high-level signal output by the third upstream relay, and the high-level signal output by the fourth upstream relay of a same material transmission channel at the same time, outputting an early warning message.

6. The material scheduling method as recited in claim 2, further comprising:
in response that the materials transmitted by a first material transmission channel among a plurality of material transmission channels are unprocessed, and the materials transmitted by a second material transmission channel are processed and qualified according to the material information, processing unprocessed materials and acquiring processed materials;
producing products using the processed materials and the processed and qualified materials.

7. The material scheduling method as recited in claim 2, further comprising:
in response that the materials transmitted by the at least one material transmission channel are processed and qualified according to the material information, producing products using processed and qualified materials.

8. The material scheduling method as recited in claim 1, further comprising:
in response that any material transmission channel does not receive any materials transmitted by the second machine within a preset time, outputting an early warning prompt.

9. A machine comprising:
a processor; and
a non-transitory storage medium that stores a plurality of instructions, which when executed by the processor, causing the processor to:
in response to a processing instruction, control a first downstream relay of at least one material transmission channel to send a high-level signal to a second machine by closing the first downstream relay, make the second machine close a first upstream relay of the at least one material transmission channel according to the high-level signal, and trigger the second machine to activate a material transmission mode;
obtain material information corresponding to materials transmitted by the at least one material transmission channel according to a classification signal fed back by the second machine;
receive the materials transmitted by the second machine, and control a mechanical arm on the first machine to separate the materials from a jig that places the materials;
in response to a return signal sent by the second machine, transmit the jig to the second machine through a jig return channel;
in response that the material information corresponding to the materials transmitted by any material transmission channel indicates that the materials are unprocessed, process the materials transmitted by any material transmission channel.

10. The machine as recited in claim 9, wherein the plurality of instructions are further configured to cause the processor to:
in response that the classification signal is a high-level signal output by a second upstream relay of the at least one material transmission channel corresponding to the second machine, determine that the material information corresponding to the materials transmitted by the at least one material transmission channel indicates that the materials are unprocessed; or in response that the classification signal is a high-level signal output by a third upstream relay of the at least one material transmission channel corresponding to the second machine, determine that the material information corresponding to the materials transmitted by the at least one material transmission channel indicates that the materials are processed and qualified; or
in response that the classification signal is a high-level signal output by a fourth upstream relay of the at least one material transmission channel corresponding to the second machine, determine that the material information corresponding to the materials transmitted by the at least one material transmission channel indicates that the materials are processed and unqualified.

11. The machine as recited in claim 9, wherein the plurality of instructions are further configured to cause the processor to:
after receiving the materials transmitted by the second machine, disconnect the first downstream relay corresponding to the at least one material transmission channel, and disconnect a communication between the first machine and the second machine.

12. The machine as recited in claim 11, wherein the plurality of instructions are further configured to cause the processor to:
in response that the materials transmitted by any material transmission channel are processed and unqualified according to the material information, remove the materials out of the first machine, and re-close the first downstream relay corresponding to any one of the material transmission channels, and continue to receive other materials.

13. The machine as recited in claim 10, wherein the plurality of instructions are further configured to cause the processor to:
when receiving at least two high-level signals of the high-level signal output by the second upstream relay, the high-level signal output by the third upstream relay, and the high-level signal output by the fourth upstream relay of a same material transmission channel at the same time, output an early warning message.

14. The machine as recited in claim 10, wherein the plurality of instructions are further configured to cause the processor to:
in response that the materials transmitted by a first material transmission channel among a plurality of material transmission channels are unprocessed, and the materials transmitted by a second material transmission channel are processed and qualified according to the material information, process unprocessed materials and acquire processed materials;
produce products using the processed materials and the processed and qualified materials.

15. The machine as recited in claim 10, wherein the plurality of instructions are further configured to cause the processor to:
in response that the materials transmitted by the at least one material transmission channel are processed and qualified according to the material information, produce products using processed and qualified materials.

16. The machine as recited in claim 9, wherein the plurality of instructions are further configured to cause the processor to:
in response that any material transmission channel does not receive any materials transmitted by the second machine within a preset time, output an early warning prompt.

17. A non-transitory storage medium, which stores instructions that, when executed by at least one processor of a machine, causes the least one processor to implement a material scheduling method, the material scheduling method comprising:
in response to a processing instruction, controlling a first downstream relay of at least one material transmission channel to send a high-level signal to a second machine by closing the first downstream relay, making the second machine close a first upstream relay of the at least one material transmission channel according to the high-level signal, and triggering the second machine to activate a material transmission mode;
obtaining material information corresponding to materials transmitted by the at least one material transmission channel according to a classification signal fed back by the second machine;
receiving the materials transmitted by the second machine, and controlling a mechanical arm on the first machine to separate the materials from a jig that places the materials;
in response to a return signal sent by the second machine, transmitting the jig to the second machine through a jig return channel;
in response that the material information corresponding to the materials transmitted by any material transmission channel indicates that the materials are unprocessed, processing the materials transmitted by any material transmission channel.

18. The non-transitory storage medium as recited in claim 17, the material scheduling method further comprising:
in response that the classification signal is a high-level signal output by a second upstream relay of the at least one material transmission channel corresponding to the second machine, determining that the material information corresponding to the materials transmitted by the at least one material transmission channel indicates that the materials are unprocessed; or in response that the classification signal is a high-level signal output by a third upstream relay of the at least one material transmission channel corresponding to the second machine, determining that the material information corresponding to the materials transmitted by the at least one material transmission channel indicates that the materials are processed and qualified; or
in response that the classification signal is a high-level signal output by a fourth upstream relay of the at least one material transmission channel corresponding to the second machine, determining that the material information corresponding to the materials transmitted by the at least one material transmission channel indicates that the materials are processed and unqualified.

19. The non-transitory storage medium as recited in claim 17, the material scheduling method further comprising:
after receiving the materials transmitted by the second machine, disconnecting the first downstream relay corresponding to the at least one material transmission channel, and disconnecting a communication between the first machine and the second machine.

20. The non-transitory storage medium as recited in claim 19, the material scheduling method further comprising:
in response that the materials transmitted by any material transmission channel are processed and unqualified according to the material information, removing the materials out of the first machine, and re-closing the first downstream relay corresponding to any one of the material transmission channels, and continuing to receive other materials.
